(19) United States
(12) Patent Application Publication
(10) Pub. No.: US 2021/0376658 A1
(43) Pub. Date: Dec. 2, 2021

(54) MODULAR FASHION ACCESSORIES WITH INTEGRATED ELECTRONIC FUNCTIONALITY

(71) Applicant: Angela Nicole Marino, San Marcos, CA (US)

(72) Inventor: Angela Nicole Marino, San Marcos, CA (US)

(21) Appl. No.: 16/886,731

(22) Filed: May 28, 2020

(51) Int. Cl. H02J 50/00; A41D 1/00; A41D 27/20; A41D 31/10; H02J 50/10

(52) U.S. Cl. CPC H02J 50/005; A41D 1/005; A41D 27/205; A45C 13/008; A41D 31/10; H02J 50/10; A45F 2200/0516; A41D 27/208

(57) ABSTRACT

The present invention is designed to allow for complete customization of a flexible item, e.g. a modular handbag system. The invention can therefore be outfitted for multi-uses, such as a personal handbag, diaper bag, backpack, insulated cooler, storage tote, satchel, laptop and work bag, or a gym bag among other uses, with handles or shoulder strap or other carrying options as applicable. Said bag system may comprise one or more outer bag shells which allow for straps and/or handles and/or modular attachments to be attached to it. An outer bag shell may house a modular inner bag outfitted with a series of fastener systems to allow for complete interior customization. Furthermore, the present invention describes a fully functional smart flexible item, e.g. smart bag that espouses a system for delivering power from a battery located in an outer bag shell, and/or in an inner bag, and/or in a modular attachment (e.g. pockets) to an outer bag shell, and/or an inner bag, and/or one or more modular attachments featuring technological components. Finally, the power delivery system can be applied to a variety of soft goods, most notably: clothing, outdoor gear, home furnishing covers, and personal accessories.

### RELATED APPLICATION DATA

This application claims the benefit of U.S. Provisional Application No. 62/854,307 filed on May 29, 2019.

### FIELD OF THE INVENTION

The present invention is in the field of flexible items, such as clothing, fashion accessories, and soft good items, more specifically: bags and handbags, coats and outerwear, but the application of the invention can be applied to a more broad category of soft goods which may include items such as outdoor tents and shade structures, home furnishing textiles such as furniture coverings, curtains, bedding and linens. From this point onward, we use the terms “bag” and “handbag” synonymously to refer to a bag held in the hand or hung from a strap or straps and used for carrying personal articles, and the terms “coat” and “outerwear” henceforth are used synonymously to refer to an article of clothing typically worn over another article of clothing. Additionally, “flexible item” and “soft good item” are herein used interchangeably between them and interchangeably with any of the above described items related to the field of the invention. The present invention further relates to the field of “smart” technology and power delivery within a flexible item. The implementation is not limited to a specific product or technology and applies to either the invention as an individual component or an inclusion of the present invention within larger systems which may be combined.

### BACKGROUND

Currently, most flexible items, e.g. handbags, fashion accessories, and outerwear, on the market are made for a single purpose, have limited organization, are difficult to clean, and lack technology advancements. A handbag, for example, is limited in its use to the extent the original design permits. If a user wants to change a single aspect of functionality or design, they often need to buy a completely different product. As such, many bag users keep a plurality of handbags to suit their different use cases and style preferences. One of the most common user complaints regarding their handbag, is the lack of, or ineffective, internal organization. To overcome this flaw, users find after-market solutions to better suit their needs. The most common custom solution currently available for interior organization comprises a single bag or cubby structure that is placed inside of the main handbag structure. This is convenient for allowing better organization in larger bags but is created in a “one-size fits all” manner which has routinely been found to be insufficient by users as the organizing structure must be placed on the bottom of the bag and inevitably becomes disorganized as the entire bag is jostled around. Another common problem with soft goods, is that they are notoriously difficult to clean, they can stain easily and are often not washable without disrupting the integrity of the overall design and materials. This is especially true for handbags, particularly structured handbags. These limitations mean that the general lifespan of the product is limited as an individual's taste and needs change or as an element of the accessory becomes unusable due to damage or defect. Furthermore, most handbags and outerwear available today do not include a seamless way to integrate commonly used technological equipment. The concept of wearable technology is fairly new; clothing, accessories, and outerwear have yet to incorporate the technology of today into their design. Some type of limited technology is starting to be placed in handbags, luggage, and travel cases; most commonly to recharge a user's mobile phone with a USB cable connecting the device to a power supply. However, these items often lack the functionality for everyday convenience and are consistently abandoned by the user.

Another attempt to make a handbag more customizable is geared toward enhanced interior organization by using hangers inside of the bag which would allow for the attachment of various organizing pocket compartment. While this solution does address a flaw in the state-of-the-art of handbag design with regard to organization, it does not address the difficulty of cleaning the handbag, nor do the hangers allow for any technological feature to be implemented inside the bag. Furthermore, such solutions do not provide the flexibility of removing the entire organization system from the bag easily, as needed, based on specific use-cases or changing the appearance of the bag to suit a user's preference. Additionally, this type of solution is limited to a specific size of a specific item and cannot be interchanged between various bag sizes or applied to other soft-good items.

Another fundamental improvement that can be added to state-of-the-art clothing, accessories and soft good items is the capability to integrate technological features. For clarity, adding such technological features elevates any standard flexible item to a “smart” version of that item (i.e. a smart flexible item). Some handbags, luggage, and travel cases are starting to include a method for recharging a mobile device, however, the bag user is required to physically attach the mobile device to the power supply with a USB cable and is burdened with the inconvenience of having to take the charger out of the bag, plug it in to recharge, and replace it in the bag before departure for each use.

It is therefore an improvement to the current state of the art to include wireless power transmission in a smart flexible item, such as a handbag, that can wirelessly transmit power as well as receive power automatically to eliminate required user intervention. In order to achieve such an improvement, it is critical that said item be constructed in a way as to create a consistent connection between the transmitting unit and the receiving unit of the wireless power transmission system. Furthermore, in order to guarantee the longevity of a smart flexible item's relevance, the technological components need to be removable and interchangeable to allow customization and adaptation to technological advancements. Furthermore, a smart flexible item should do more than just charge electronic devices, it should have the capability to complement a user's life in a multifaceted way. In one example a smart flexible item may be a smart bag, or a smart coat, which can sanitize selected items (e.g. baby accessories, user's phone, keys, or other personal items) and allow the user to vocally connect to their wireless devices (e.g. to add an appointment to their calendar) without having to remove or physically interact with the device (e.g. the phone) located in the smart bag, or smart coat, pocket. In another example, the smart flexible item may be a smart chair and/or a smart sofa covering which has wireless mobile device charging capabilities while remaining washable and interchangeable to meet evolving design preferences.

Therefore a need exists for new types of soft good items which can offer customization and technology to help with the most common daily tasks while remaining highly specific to the user's personal taste. It is therefore a purpose of the present invention to describe a novel soft good item which can be a bag, coat, or other flexible item for indoor and/or outdoor use that offers to the user the ability to customize which technological and/or organizational features best fit their needs by utilizing various attachable modular components such as different pocket and/or pouch sizes and styles which include tech and non tech elements to resolve the tech and organizational limitations of the products currently available. Elements of the present invention can be applied to advance the state of the art of present day soft good items, e.g. a handbag, coat, or camping tent, by allowing any number of a la carte tech features to be connected directly to the soft good item. The removable nature of the modular elements allows for the pockets/pouches/a-la-carte-accessories to be transferred from one product to another. Allowing for a seamless flow for the user.

### BRIEF SUMMARY OF THE INVENTION

The present invention describes a modular system in which a selection of a la carte components may be removably paired with a host soft good item which may be part of a series of soft good items. The present invention describes a flexible item which may comprise one or more of the following: a first and a second layer, a power delivery system, and a fastening system. The power delivery system may comprise a conductive path, wherein the conductive path may be located between said first layer and second layer. The fastening system may comprise a first and a second portion, wherein the first portion of the fastening system is physically attached to the first layer and electrically coupled to the conductive path. A further embodiment of the present invention describes a modular bag comprising a first container, made of a first flexible material, a second container made of a second flexible material, and a fastening system. The first container may comprise a first and a second opposing sidewall and may have a first opening proximate to the top. The second container may comprise a third sidewall and a fourth sidewall and may have a second opening at the top. The fastening system may comprise a plurality of first and second portions, wherein the plurality of said first portions are physically attached to the second container. The first container may comprise an aperture for removably attaching a strap or handle to said first container. The present invention further describes a bag comprising a first container, and a storage system. The storage system may comprise a first and a second storage area, a wireless charging coil, and a power supply. The first container may comprise a first and a second opposing sidewall, wherein the first sidewall may comprise the first storage area and the second storage area. The first and second storage area may be at least partially overlapping. The wireless charging coil may be stored at least partially in said second storage area and be electrically coupled to the power supply.

### BRIEF DESCRIPTIONS OF THE DRAWINGS

The features, objects, and advantages of the present invention will become apparent upon consideration of the following detailed description of the invention when read in conjunction with the drawings in which:

FIG. 1 is a first embodiment of a modular handbag according to the present invention, within which one or more of the devices, methods, systems and/or components described further herein will be applicable. FIG. 1A shows a complete handbag external view. FIG. 1B shows an inner bag of a modular handbag system. FIG. 1C shows a top view of a modular handbag system where an inner bag is placed inside of an outer bag shell.

FIG. 2 shows a side-view of a modular handbag system according to a further embodiment of the present invention, where two possible multi-use strap configurations are shown. FIG. 2A shows a modular handbag with a long strap made from connecting multiple strap lengths. FIG. 2B Shows a modular handbag with a wristlet strap using a singular strap length.

FIG. 3 shows a side-view (FIG. 3A) and a top-view (FIG. 3B) of an outer bag shell of a modular handbag system according to a further embodiment of the present invention.

FIG. 4 shows side-view (FIG. 4A) and top-view (FIG. 4B) of an inner bag of a modular handbag system according to a further embodiment of the present invention.

FIG. 5 shows an example of inner side of an inner bag wherein six snaps have been placed in a semi-permanent way to form a 2 by 3 matrix to which modular pockets can be connected.

FIG. 6 shows an example of interior of the inner bag wherein 4 modular pockets have been connected.

FIG. 7 shows the x-ray view of an inner bag according to a further embodiment of the present invention where six snap fasteners have been connected to the power supply wiring with an optional cord to plug into the power supply.

FIG. 8 depicts a cross section of a smart bag according to the preferred embodiment of the present invention, where multiple modular technological features have been added in the inner and outer bag shell.

FIG. 9 shows an outer side (FIG. 9A) of an inner bag according to a further embodiment of the present invention, with two snap fasteners and an optional power snap fastener to be secured to the outer bag shell and power supply. FIG. 9B shows a top view of an inner bag and snap fasteners.

FIG. 10 shows a top view of an outer bag shell according to a further embodiment of the present invention, where a power supply has been added to the bottom of the bag to supply power to the technological modules.

FIG. 11 shows an x-ray view of a modular bag wherein the power delivery system and power supply are embedded within the first and second layer of the bag.

FIG. 12 illustrates an x-ray view of an inner bag according to the embodiment of FIG. 2, where a wireless power transmitting device has been added to the storage system of the bag to supply power to a user's mobile devices.

FIG. 13 illustrates an x-ray/break out view (FIG. 13A) of an inner bag storage system and a cross-section view (FIG. 13B) of the inner bag construction to support an embodiment of the storage system.

FIG. 14A is break out view of a wireless power transmitting/receiving device according to the embodiment of FIG. 12 able to recharge wirelessly and to supply power to a user's mobile devices when needed. FIG. 14B shows a layered side view of a wireless power transmitting/receiving device with possible input/output ports.

FIG. 15 shows a side view of a further embodiment of the present invention, where a charging base is used to charge wirelessly a smart handbag according to the present invention.

FIG. 16 shows a block diagram of a possible power delivery route according to the present invention.

FIG. 17A shows a view of an example embodiments of the wireless charging base according to the present invention. FIG. 17B shows a second example embodiment of the wireless charging base.

FIG. 18 shows a side view of a further embodiment of the present invention, where a charging base is used to wirelessly recharge a power supply inside a handbag.

FIG. 19 is a further embodiment according to the present invention depicting a modular smart coat (FIG. 19A) and a corresponding wireless charging hanger (FIG. 19B).

### SUMMARY OF THE INVENTION

The present invention will now be described in detail with reference to certain embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known details have not been described in detail in order not to unnecessarily obscure the present invention.

### Modular Handbag System with Interior Organization

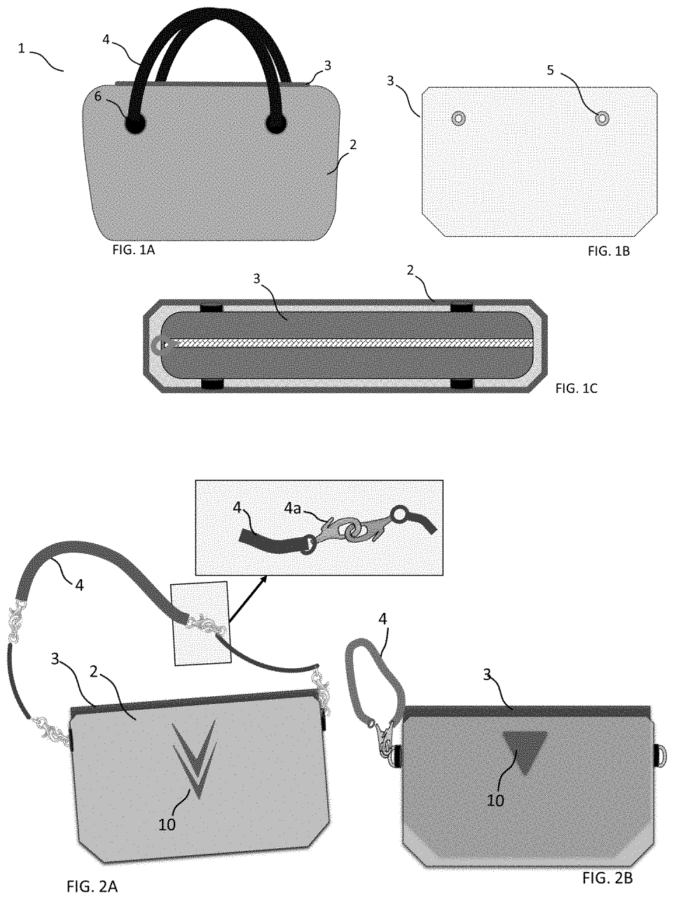

The present invention is designed to allow for the complete customization of a flexible item, such as modular handbag systems, as shown in FIGS. 1-4. The modular handbag is considered a “host” item of a system described herein and comprises one or more of the following elements: one or more containers as an outer bag shell, one or more containers as an inner bag, one or more straps or handles, one or more mechanisms to secure said inner bag to said outer bag shell, one or more mechanisms to secure said straps or handles to said outer bag shell, one or more modular, a la carte attachments (e.g. pockets), one or more mechanisms to secure one or more of said modular attachments to said inner bag or said outer bag shell. Furthermore, the modular handbag system as described may also comprise a power delivery system which may comprise a conductive path (or wireless coupling mechanism) to transfer power from a power supply source to the one or more modular attachments. The present invention allows for the power delivery system to be embedded in any flexible item to provide a way for said flexible item to become a “smart” item by connecting electronic attachments.

In order to better understand the main concept of the present invention, let us consider the exemplary system illustrated in FIGS. 1-11, which is specifically designed for use as a handbag, and represents one of the possible embodiments of the present invention.

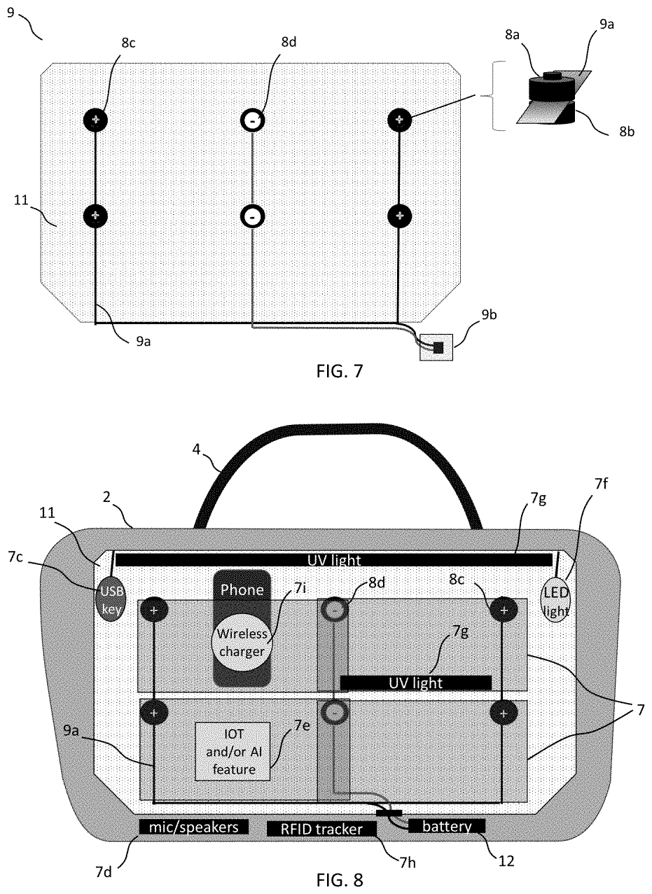

The modular handbag system (1) comprises an outer bag shell (2), an inner bag (3), one or more handbag straps or handles, also referred to as “multi-use straps” (4), a mechanism (8) to secure the inner bag to the outer bag shell (5), a mechanism to secure the handbag straps or handles to the outer bag shell (6), optional modular attachments (7a, 7b), a mechanism to secure, in a modular fashion, one or more of the inner modular attachments (7) (as shown in FIG. 7) to the inner bag or outer bag shell, and an optional power and/or signals delivery system (9).

### Multi Use Strap

The mechanism (5) to secure the inner bag to the outer bag shell (2), and the mechanism (6) to secure the handbag straps or handles (4) to the outer bag shell allows for easy connection/disconnection enabling the user to assemble and/or disassemble the system without the use of tools. A similar approach is used for the modular attachments (7) of FIG. 6 which can be added or removed from the inner bag according to user preferences.

In any of the envisioned handbags, a multi-use strap feature can be included. As shown in FIG. 2, the strap or handle (4) can be connected to the bag and/or to additional strap or hand components with the connection mechanism (4a). Shown in FIG. 2 is how the strap feature may be configured for a shoulder carry (FIG. 2A) and/or a wristlet (FIG. 2B) for a small size bag.

### Outer Bag Shell

The outer bag shell (2) can be made, for example, of a non-porous, semi-rigid material that is comprised of at least two sidewalls connected to a bottom base with an opening at the top allowing access to the interior for the purpose of carrying personal belongings. Each of the above elements may comprise multiple layers (also glued or deposited on top of each other), if desired of different materials, with additional components in between these layers. For example, a power delivery system (9) as shown in FIG. 7, and/or a power supply may be embedded between the multiple layers of said materials (FIG. 7).

The semi-rigid material and the peculiar geometrical characteristics, ensure that the outer bag shell can self-stabilize and hold an upright position (opening at the top) when the bottom is placed on a flat surface such as floor or a table, without the intervention of the user and without any additional external support. This enables the content of the bag systems to be safely stowed and easily accessible at any time, even when the bag system is not carried or actively kept in standing position by the user. The semi-rigid material furthermore avoids significant deformation of said geometry and preserves the opening at the top, enabling for easy unobstructed access to the interior.

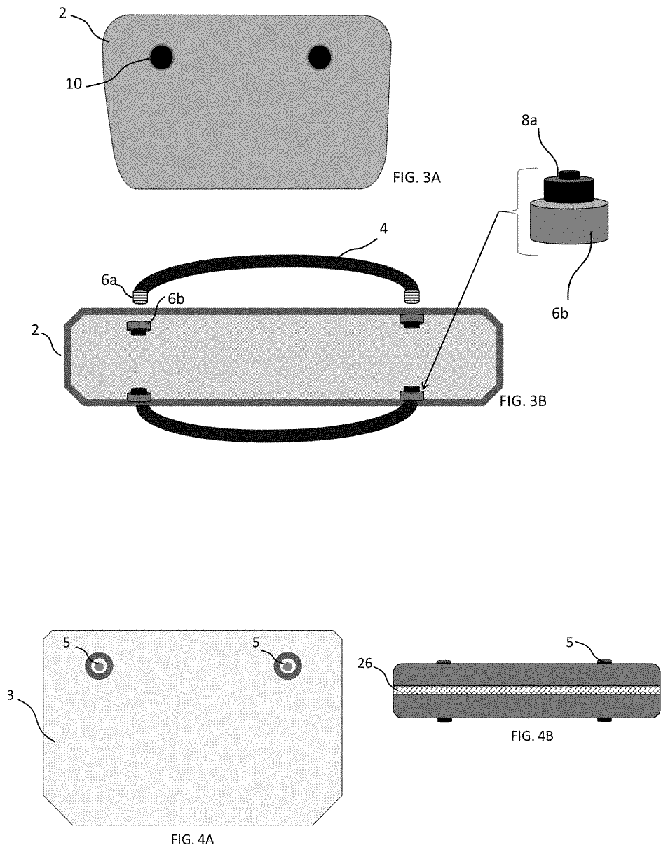

The outer bag shell described above can be created with one or more interruptions, or apertures, in the material so as to provide a means for pass-through capability to accommodate the attachment of straps or handles, and/or other modular attachments used for carrying and accessorizing the complete bag system. In the embodiment of FIG. 3 a set of apertures have been added along the top edge of the outer bag shell (2) near a top opening to allow for straps or handles (4) to be connected to the outer bag shell. Other interruptions in the material (10) may be created in the outer bag shell to allow the use of additional modular attachments, such as speaker and/or microphone and/or other modular attachments (7) of FIG. 6 as further described herein. Furthermore, apertures (10) can be implemented in the material to improve the ventilation of an element of a power delivery system. Additionally, interruptions to the material (10) can be created to allow for semi-permanent decorative features on the outer bag shell (2).

As shown in embodiment in FIG. 3, the mechanism to secure the handbag straps or handles to the outer bag shell (6) may comprise plastic screws (6a, 6b) permanently attached to the straps or handles. In this embodiment, the outer bag shell (2) presents at least one aperture (10) made to accommodate said plastic screw (6a). A screwcap (6b) is then used on the inner side of the outer bag shell to hold the screw (6a) (and therefore the strap or handle end) in place. Said screwcap (6b) may also comprise one part (8a) of a two-parts fastening snap that is used to connect the inner bag (3) to the outer bag shell (2).

Alternatively said plastic screw can also pass-through an aperture (10) through both the inner bag (2) and the outer bag shell (2) to join the three parts. In the latter case the screwcap (6b) is used to hold in place the plastic screw (6a) from the inner side of the inner bag (3). Another example envisions the straps-or-handles ends to loop through and/or around an aperture (10) of the inner bag (3) and/or the outer bag shell (2) so as to join together the three modules (inner bag (3), outer bag shell (2) and straps-or-handles (4)).

Another example envisions the straps-or-handles ends to loop through and/or around one or more apertures (10) in the inner bag (3) and/or the outer bag shell (2) from one side to the other side so as to join together the five modules (two inner bag sidewalls, two outer bag shell sidewalls and one strap-or-handle), so as when the user picks up the bag, the two inner bag sidewalls and the two outer bag shell sidewalls are pushed towards each other so as to close the opening at the top. However, many other mechanisms can be used to connect the handbag straps or handles, the outer bag shell and/or the inner bag together including one or more variations of fastening snap systems, magnets, zippers, hook and loop, buckles, clips, clasps or other mechanism that provides the opportunity for two items to be joined in a semi-permanent fashion as described in several embodiments herein.

In another embodiment, the outer bag shell (2) may comprise a structure like a backpack, comprising a bottom layer, multiple side walls and a top layer comprising a fastening system to close the shell. In such a case the strap or straps (4) may be permanently or semi permanently attached to the top and or bottom of one of the side layers, enabling a supporting structure to be placed on the shoulders.

In another example, the outer bag shell (2) may comprise a hand purse. In such a case the straps (4) may be connected permanently or in a removable way to one of the sides or at the junction between sides.

### Inner Bag

Shown in FIGS. 4A and 4B, is a side and top view of the inner bag (3), respectively. The inner bag may comprise at least two sides that leaves an opening at the top allowing access to the interior space between the at least said two sides and may comprise additional sides connected at the bottom and a closure at the top. Each of the sides may include one or more apertures. Each of the sides may comprise multiple layers, if desired, of different materials with additional components in between these layers; In one example one or more of the sides may comprise a first layer and a second layer, wherein the said power delivery system comprises a conductive path (9a) described above is hosted between the first layer and the second layer. The inner bag structure may be of various types of materials which may be washable.

To secure the inner bag to the outer bag shell, the inner bag mentioned above may have one or more portions of a fastening system (5) permanently attached to one or more of the sides, bottom, or top closure. Such fastening systems may be secured to the inner bag in a multitude of ways, which comprises being glued to the inner bag material, sewn into or onto the material, or by using a two part fastening system that may exploit an aperture in the inner bag.

An inner bag can have one or more portions of a fastening system for any interior side, top or bottom. Furthermore, the fastening system can comprise one or more variations of snaps, magnets, zippers, hook and loop, clips, buckles, clasps or other mechanism that provides the opportunity for two items to be joined together in a semi-permanent fashion as described in several embodiments herein.

Similarly, the outer bag shell mentioned above may have one or more portions of a fastening system (5) permanently attached to one or more of the sides, bottom, or top closure. Such fastening systems may be secured to the outer bag shell in a multitude of ways, which comprises being glued to the outer bag shell material, embedded within the material, or by using a fastening system that may exploit an aperture in the outer bag shell.

In another example a fastening system may be used to connect the outer bag shell to the inner bag by passing through an aperture in the inner bag and a corresponding aperture in the outer bag shell. In this case, one or more portions of a fastening system (5) may be on the outside of the outer bag shell and one or more portions of a fastening system may be on the inside of the inner bag. In such a case, the fastening system may be fully or partially removable from one or more of the modular bag elements.

### Mechanisms to Secure the Modular Attachments to the Inner Bag

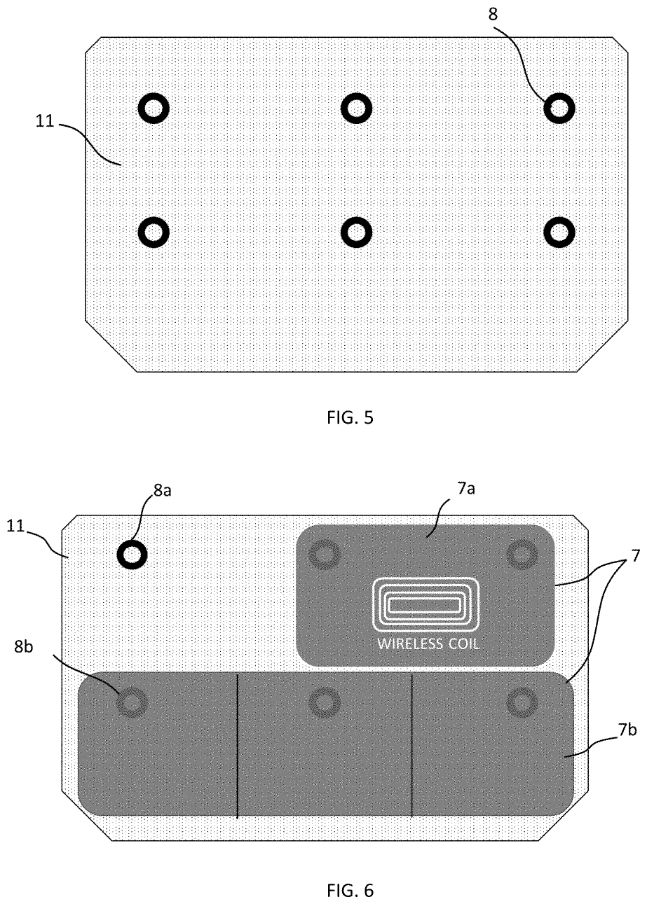

As shown in FIGS. 5 and 6, which illustrate a side-view of an inner sidewall (11) of an inner bag (3) according to a further embodiment of the present invention, the inner bag described above can be created for the purpose of securing modular attachments (7) such as pockets with or without technological elements, organizing compartments, technological and non-technological accessories, and other modular attachments to the inner bag. In this case, the inner bag has one or more portions of a fastening system mechanisms (8) permanently attached to one or more sidewalls (11) of the inner bag (3).

In general, each of such fastening system mechanisms may be secured facing, and be accessible from, the inner side of the flexible item (or a component thereof, e.g. inner bag) or the outer side of the flexible item. Such fastening system mechanisms allows for securing various modular attachments (7) (e.g. pockets and/or accessories) to the said flexible item for complete user customization.

As shown in FIG. 6, differently dimensioned modular attachments (7a, 7b) that contain at least one portion of a fastening system (8) on the exterior edge can, therefore, be attached to a second portion of a fastening system located on the flexible host item described above.

The fastening system (8) used to attach the modular attachments to the flexible item, or to one or more of its components (e.g. inner bag), can comprise one or more variations of snaps, magnets, zippers, hook and loop, clips, clasps, buckles, or any other mechanism that provides the opportunity for two items to be joined together in a semi-permanent fashion as described in several embodiments herein.

### Modular Attachments

The one or more modular attachments that may be secured to said flexible item or to one or more of its components, may comprise a variety of items to satisfy the user's needed functionalities. In the following, several modular attachments embodiments are described as examples, but the description is not exhaustive nor limiting and several other modular attachments may be envisioned to enrich the functional modularity of the entire system.

In one embodiment of the present invention one or more of the modular attachments may be a pocket comprising or not comprising technological elements. Such pocket can be made of rigid, semi-rigid, or soft materials, or insulating materials (e.g. thermal insulators) or a combination of them.

With reference to FIG. 6, each of the different dimension pockets (7) comprises at least two sidewalls leaving an opening at the top so as to allow access to the interior space between the said at least two sidewalls, and may comprise additional sides connected at the bottom, lateral walls, and/or a closure on the top. Each of the sides of said pocket may comprise multiple layers with or without technological elements between them. If desired, one or more of said pockets can be divided into multiple sections or “sub pockets” and may include technological elements or not (7b).

In a further embodiment of the present invention, one or more of the modular attachments (7) may be an enclosure which may be used to host functional elements such as but not limited to electronic, mechanical, or decorative devices. As another example, a modular attachment may comprise a support system with additional fastening mechanisms for holding objects such as keys, pens, phones, etc. As another example, a modular attachment may comprise a bottle holder, which may include a strap or cup or pouch to secure a bottle.

As another example the one or more modular attachments (7) may comprise electrical or electronic components and/or devices, or may comprise enclosures that host electrical or electronic components and/or devices such as:
A memory unit and/or an IC controlling unit to coordinate the technological components attached to the flexible item
A solid-state memory device (e.g. USB key) and/or a USB charge port
Microphone and/or speakers, with associated IC controlling unit
Voice interacting system/interface
Portable power supply
Cooling, and/or refrigerating device
Video camera and/or photographic camera
IoT and/or AI (artificial intelligence based) devices
One or more LED (Light Emitting Diode) lights,where one or more of these lights may comprise one or more sensors (e.g. motion and/or light sensor) that allow automatic turn on/off features when the flexible item is engaged by the user
One or more Ultraviolet (UV) LED lights, where one or more of these lights may comprise one or more sensors (e.g. motion and/or light sensor) that allow automatic turn on/off features when the flexible item is engaged by the user so as to allow for the item's sanitization
A wireless charging system (an entire wireless transmitter system and/or an entire wireless receiver system, or only some of the components such as the coil or the IC unit)
Sensors for temperature, light, movement (accelerometer, magnetic orientation)
   It is important to notice that these are just few examples to illustrate the technological modularity of the present invention and it is not intended in any way to limit the scope or features of the present invention, many other devices and technologies can be added to the above list of electrical modular attachments/components.

One or more of the above technological features can be included through one or more modular attachment for the host flexible item to make it a “smart” flexible item. For example, the smart flexible item can comprise one or more of the following modular attachments connected to a host item (i.e. handbag, tent, couch cover):
A pocket or enclosure accessory that includes a wireless charging device (the entire wireless transmitter or receiving system, or only some of the components such as the coil or the IC unit) that can be secured to a sidewall and is connected to the power supply (or to the rest of the wireless charging circuit) once the fastening system is engaged;
A pocket or enclosure accessory that comprises a UV LED light that connects to a power supply once the fastening system is engaged; this light may comprise one or more sensors that allow the UV LED to automatically turn on for a limited amount of time when the user ceases interaction with the item (e.g. when a user closes a handbag);
A pocket or enclosure accessory that comprises a voice activated speaker which may utilize a user's phone's mobile network to connect to a voice-assistant software that connects to a power supply once the fastening system is engaged.
   Also these are just a few examples to illustrate the technological modularity of the present invention and it is not intended in any way to limit the scope or features of the present invention, many other devices and technologies can be added to the above list of electrical modular attachments/components.

Furthermore, one or more of the electronic modular attachments may comprise communication capabilities, through electrical or electromagnetic signals, e.g. by using wireless communication protocols such as Wi-Fi, Bluetooth, or similar. The one or more modular attachments may communicate with one or more of other modular attachments which has compatible communication capabilities. The one or more modular attachments may communicate with one or more external processing devices, such as smartphones or computing units; such external processing device may include software apt at collecting data from the one or more modular attachments part of the bag system, and processing that data to provide the user with a desired information regarding the smart flexible item's system. Depending on the specific capabilities of the modular attachments, the information may comprise for example a location, movement, temperature, state of internal component of the smart flexible item's system (e.g. charging status of the embedded battery). Such external processing device may furthermore instruct, automatically or under the user supervision, the one or more modular attachments to perform specific functions, depending on their capabilities; such functions may include turning on/off specific electronic components (such as a light), play music etc. Such communication and control capabilities extend the smart flexible item's systems by including external processing devices and providing additional functionalities to the system to further enhance customization.

### Power and/or Signals Delivery System

In agreement with a further embodiment of the present invention shown in FIG. 7, the inner bag (3) may also comprise a power delivery system (9) that enables the powering (e.g. through a fastening system (8)) of one or more of modular attachments that can be removably connected to said inner bag, and/or the powering of the electrical devices stowed within the modular attachment. A similar power delivery system and/or a simplified version can be created also in the outer bag shell if desired, for example to transfer energy from the outer bag shell to the inner bag or to a set of modular attachments, such as pockets, attached (inside or outside) the outer bag shell. In either case, the power delivery systems can be embedded inside the side walls and/or bottom side (e.g. if the sidewalls and/or bottom side are composed by multiple layers) or it can be simply attached to it.

The snaps or other aforementioned fastening mechanism (8) can comprise at least one portion made of a material that conducts electricity so as to deliver power (or electrical signals) from/to the flexible host item and/or to deliver power from/to the modular attachments (7). The said portions made of conductive material are then coupled to at least one electric wire or fabric or surface (9a) used to deliver power (or an electrical signal) to the fastening system (8).

The power may be delivered by using wires (9a), in which case the fastening system (8) must be designed to allow for one or more wires to pass through one or more portions of the system. In another embodiment the power may be delivered between the outside and inside of a flexible item with a wireless power transfer system, which may comprise a device on the outside and one on the inside of the flexible item, and/or outside and inside of a pocket/modular attachment (7).

If the system uses a single portion of a two-part fastening system to deliver both positive and negative polarity from the battery, the fastener must be adapted so as to isolate the positive terminal from the negative terminal at all times. Alternatively, as shown in FIG. 7, a separate fastener can be employed for each polarity (8c, 8d) to simplify the system implementation.

It is important to notice that the above described fastening system can comprise snaps, magnets, zippers, hooks and loop tape, clips, clasps, buckles or any other mechanism that provides the opportunity for two items to be joined together in a semi-permanent fashion. All these mechanisms can then be modified to allow for power delivery to a flexible, soft good item (e.g. a handbag, jacket, tent, sofa cover, or any other host item).

The power delivery system (9) may further comprise pathways of conductive material (9a) that allow for the delivery of power across two or more of said fasteners (8). Such a conductive material may comprise a wire or a metal string or a metal surface or a fabric made of conductive properties, which may be secured to the inside and/or outside of the flexible item or embedded within.

If desired, at least a portion of the power delivery system inside the flexible item and/or the modular attachments can be used for functions different from just powering the technological components inside the smart system. For example, said portion of the delivery system can be used to enable the transfer of communication signals from one attachment to another. Such communication signals may enable exchange of information or functional signals, connecting a portion of a circuit contained in one modular attachment to another portion of a circuit contained in another modular attachment, or in the flexible item.

Additionally, at least a portion of said power delivery system can be used to transfer power from one modular attachment (e.g. comprising a battery) to another (e.g. comprising an electrical load).

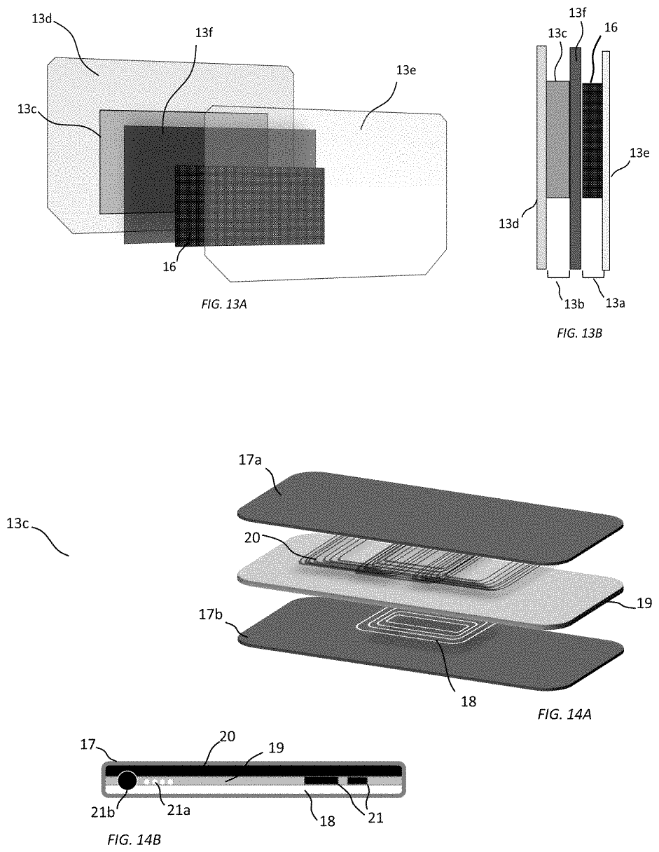

Furthermore, to create an advantage for a smaller flexible item, e.g. a small handbag, that may not have the need for modular organization or the said fastening system, a reduced, or simplified, version of the said power delivery system may be used (FIG. 12). As an example, the flexible item may comprise a storage system in which a first storage compartment (e.g. pocket) (13a) at least partially overlaps a second storage compartment (13b) in which a simplified power delivery system is permanently or removably housed (13c).

One or more portions of said storage system in the smaller flexible item may comprise electrical or electronic components and/or devices, or may comprise enclosures that host electrical or electronic components and/or devices as elements of the reduced power delivery system.

It is important to notice that the power delivery system herein described and the capability to deliver power through a fastening system (such as a two-part fastening snap system) can also be adapted to any bag, clothing item, indoor-use textile, or outdoor-use textile e.g. a wireless charging device (the entire wireless transmitter or receiver system, or only some of the components such as the coil or the IC unit) that connects to a power supply embedded in a handbag (or to the rest of the wireless charging circuit) with a two-parts snap system.

Any concept, method and/or embodiment discussed herein, including the modular attachments implementation, applies to either the invention as an individual component or an inclusion of the present invention within larger systems which may be combined.

Many details of the present invention are shown in FIG. 1-FIG. 8, where an example of implementation of the modular principle is depicted in a modular handbag system (1). The main components that allow for the modular approach are: A screw-cap (6b) with one part of a two-parts fastening snap system (5) permanently attached to the cap end; an inner bag (3) that has four first parts of a two-parts fastening snap system (5) on the exterior of the inner bag for the purpose of securing the inner bag to the handbag straps (4) inside the outer bag shell; said inner bag having one or more first parts of a two-parts fastening snaps (8) permanently attached (e.g. in rows or any other configuration) on the interior walls and/or base and/or top (11) for the purpose of securing various pockets and modular attachments (7) for complete user customization. Inner pockets and modular attachments (7) that comprise one or more half-parts of a two-parts fastening system (8) on the exterior edge to be attached to the inner bag described above.

A cross section of a further embodiment of the present invention is shown in

FIG. 8 which shows a technological version of the modular handbag system in accordance with a further embodiment of the present invention. In such implementation, a set of electrical wires (9a) have been embedded in the sidewalls of the inner bag (11) so as to distribute electrical power to different points inside the bag and allow for the connection of different modular electrical components (7) to the bag battery source (12). More to simplify the connection of the electronic features, the electricity can be passed through a set of snaps (8c, 8b) to which the components can be attached to. Other mechanisms are however possible.

As it can be seen, thanks to the power delivery network, the depicted handbag has been customized to include some of the technological components previously discussed. In particular, the illustrated example includes:
1) A retractable USB memory stick (7c).
2) Microphone and/or speakers with associated IC controlling unit for voice command interaction (7d).
3) IoT and/or AI (artificial intelligence based) devices (7e).
4) LED lights with motion and light sensors which automatically turn on when the bag is opened by the user (7f).
5) Ultraviolet (UV) LED lights with sensors that automatically turn on for a limited amount of time when the user closes the bag to allow for complete internal handbag sanitization (7g).
6) A tracking RFID/Bluetooth system (7h).
7) A wireless charging system that allow the user to place the phone in the dedicated pocket to make it charge, without the need to connect any wire (7i).
8) A pocket for the inner bag that includes UV LED lights that connects to a power supply once the 2-part snap system is engaged; this light may comprise one or more sensors that allow the UV LED to automatically turn on for a limited amount of time when the user closes the bag and/or pocket (7j).
(9) Power supply (12).

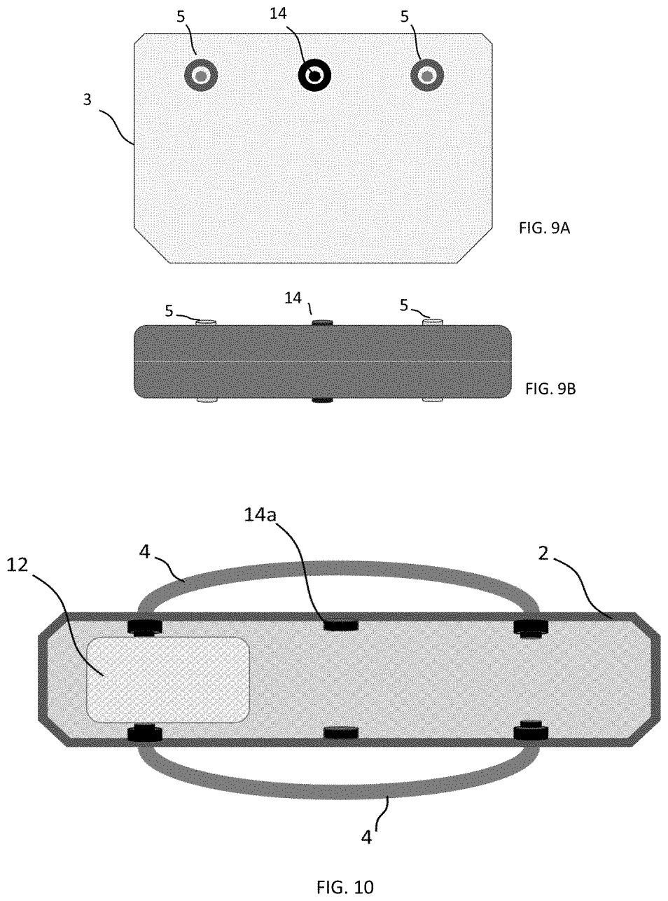

A further implementation of the present invention is shown in FIG. 9 and envisions an inner bag as described above that secures to the interior side of an outer bag shell (2) by snapping or otherwise securing the inner bag to the straps or handles (connected to the outer bag shell) and/or directly to the outer bag shell itself via snaps. Differently from the previous embodiments, in this implementation example an extra set of snaps (14) have been added which can be used to connect the inner bag to the outer bag shell and/or to carry power from/to the outer bag shell to/from the inner bag. This is an ideal setting for when the power supply may be embedded within the layers of the outer shell (2). Alternatively, also the set of fasteners used to connect the straps to the outer bag (6) can be adapted to deliver power to the inner bag.

Another embodiment of the present invention is illustrated in FIG. 10, where the connection between the power supply (12) and the outer bag shell and/or the inner bag and/or other technological features inside the modular handbag system has been implemented through an additional snap system (14b) (comprising one or more snaps). Alternatively, the connection between the power supply (12) and the outer bag shell and/or the inner bag and/or other technological features inside the modular handbag system can be done directly with one or more electrical wires. In general, the power supply can be made from a variety of materials and may be temporarily or permanently placed in the outer bag shell.

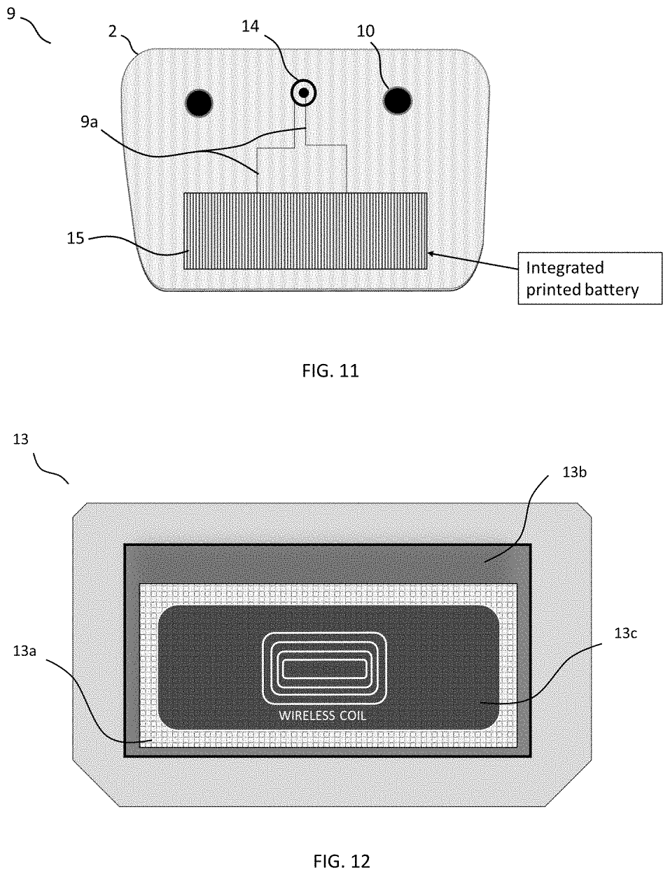

A further embodiment of the present invention is shown in FIG. 11, where a power delivery system is embedded within the outer bag shell. This embodiment shows how a conductive path (9a) and a rechargeable power supply unit (15) can be fully concealed in a waterproof environment. In one example the outer bag shell may comprise a first and a second layer and the conductive path may be hosted in between said layers. The power-providing connector (e.g. snap) (14) allows an inner bag (3) to be coupled to the power delivery system (9).

### Compact Power Delivery System

A small-sized bag, as the one shown in FIG. 12, would benefit from an internal storage system that may store a power supply (e.g. a battery), which may be housed with a wireless transmitter in the same case (13c), as a way to wirelessly charge a user's compatible device rather than an embedded distributed power delivery system. Such a wireless transmitting device (13c) may comprise one or more of the following elements in the same housing case: one or more wireless receiver, one or more rechargeable battery, one or more wireless transmitting coils, one or more control circuitry.

As can be seen in FIG. 13, the storage system of such a bag could remain out of view by layering the storage compartments (13a, 13b) between the exterior (13d) and interior (13e) material layers. Ideal placement for the wireless transmitter case (13c) would be in the storage compartment (13b) furthest from the interior layer (13e) and a user's compatible device (16) would be placed in the storage compartment (13a) closest to the interior layer (13e). The most important characteristic of such storage system is its capability to maintain a good alignment between the wireless transmitting device and the user's compatible device to maintain a good electromagnetic coupling between one or more receiving coils (of the user's compatible device (16)) and the one or more transmitting coils of the wireless transmitting device (13c).

FIG. 14A depicts a break out view of an embodiment of the wireless transmitting device (13c) in FIG. 10, where one or more wireless receiver coils (18), one or more rechargeable batteries (19), one or more wireless transmitting coils (20) and one or more control circuits housed between the walls (17a, 17b) of the power unit (13c). The one or more wireless receiving coil (18) are used to recharge the battery (19) and the one or more wireless transmitting coils (20) are used to wirelessly recharge said user's compatible device. FIG. 14B depicts a side view of the wireless transmitting device (13c). As shown, additional components may be present that allow for wired power transfer and status indication of the wireless transmitting device such as LED indicators (21a), a turn on/turn off button (21b) USB input/output ports (21) all of which being optional elements of 13c.

### Wireless Power Base

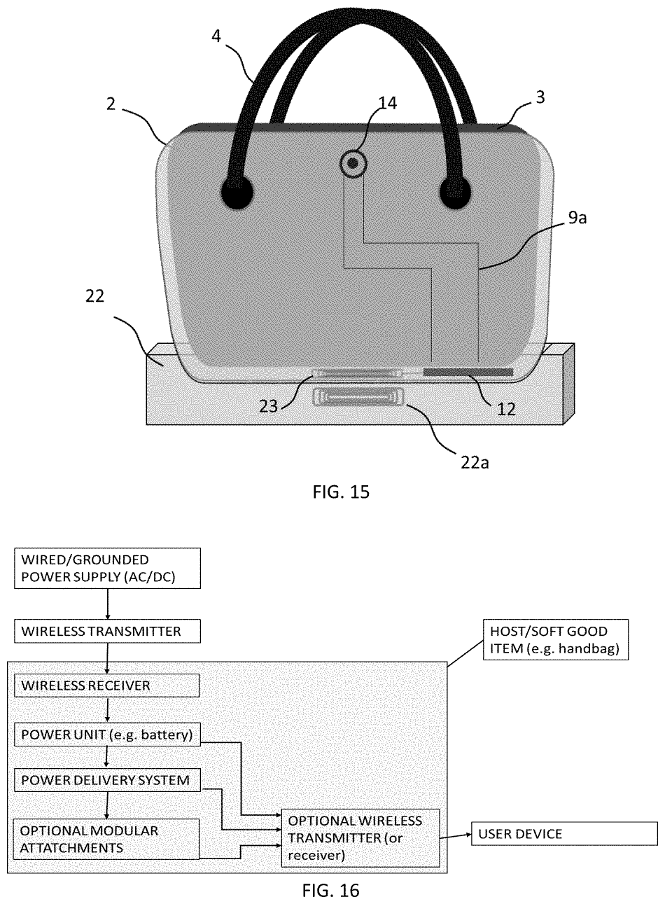

A further embodiment of the present invention is shown in FIG. 15, where a power charging base (22) comprising a wireless transmitter (22a) is used to wirelessly charge a battery and/or other devices hosted inside the smart handbag system. In this example embodiment, a wireless power receiver (23) is added to the smart handbag and it is connected to its power supply (9) to allow for the intended added functionality. The capability of the bag to charge wirelessly allows the user to easily charge the main battery (12) of the smart handbag and at the same time anything connected to it, including eventual mobile devices that have been placed inside the bag to be charged wirelessly. The wireless power system can use a resonant or non-resonant approach to transmit and receive power. If desired, the modular handbag system can allow also for the battery to be charged through a wiring system such as a USB port.

Presented in FIG. 16 is a block diagram of a possible implementation of the power delivery system in the soft good item and the charging base. As can be seen from the figure, a grounded power supply may be connected to a wireless power transmitter which may wirelessly couple to a receiver unit hosted in the soft good item (e.g. handbag) as a way to recharge the internal power system. The wireless receiver may be coupled to a power unit (e.g. battery) which may or may not include a wireless transmitter and/or may or may not be connected to an optional power delivery system (e.g. conductive path and conductive snap-style, or similar, fasteners). The power delivery system may be connected to optional modular attachments (e.g. UV sanitizing light) and/or a wireless transmitter (or receiver). Furthermore, the modular attachments may include a wireless transmitter or receiver to which a user's device may wirelessly connect.

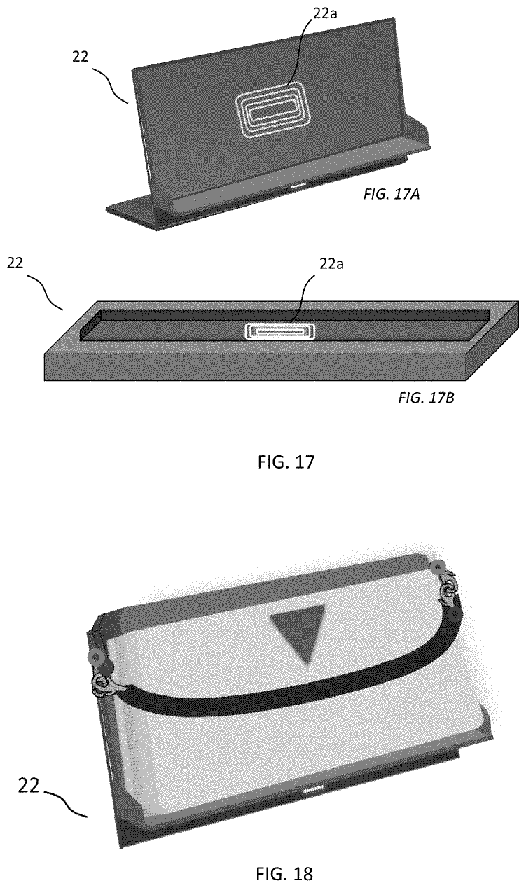

FIG. 17 depicts two example embodiments of the wireless charging stations used to recharge the power supply within the handbags. The vertical charging station presented in FIG. 17A is useful to hold smaller handbags in an upright position. A flat, or horizontal, charging station shown in FIG. 17B is the preferred method to hold a larger bag, however, there is no limit to which sized items can be used with a particularly styled charging base. These figures are offered as an example of what one may look like when created to pair with a modular handbag system according to the disclosed invention.

Large handbags with embedded power delivery systems, as shown in FIG. 15, would use a horizontal, flat, or cradle-like charging station shown in FIG. 17B to ensure proper transmitter (22a)/receiver (23) alignment while the bag remains upright. In smaller handbags, or in the case where a simplified wireless power transmitting power supply (13c) would be stored as shown in FIG. 12, a vertical charging station as the one shown in FIG. 17B would be used to recharge the power supply unit inside the bag, so as to keep personal items properly and safely stored in the handbag despite the placement of the power supply.

A preferred embodiment is exemplified in FIG. 18 which shows a handbag according to the present invention which sits on a wireless charging station in an upright position. The charging station (22) keeps the handbag system in an ideal position for storing items safely while recharging the handbags power supply located within the bag's interior.

### A Variety of Applications

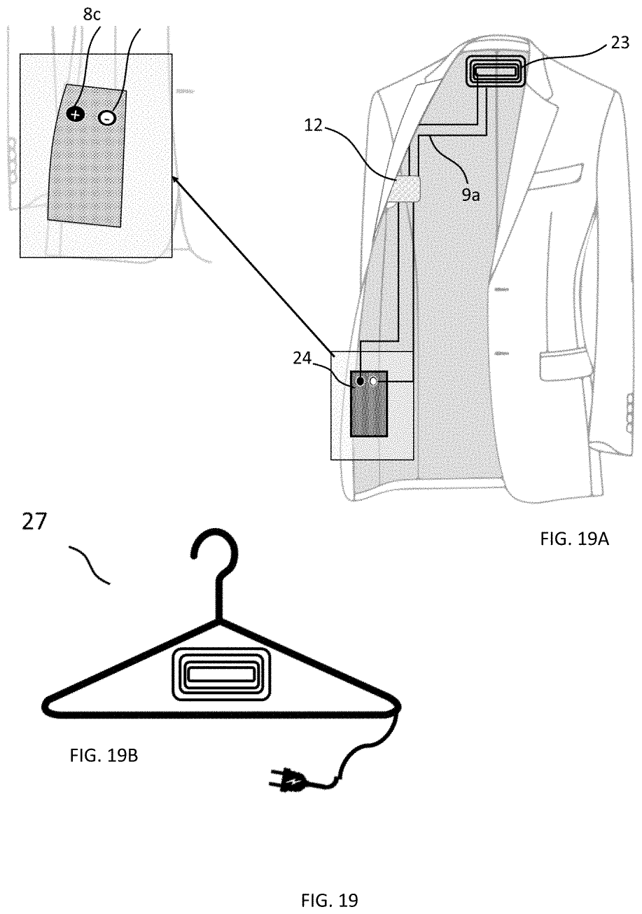

The power delivery system shown in FIGS. 8-12 can be applied to any flexible item which would benefit from having such a system. An exemplary embodiment of such is seen in FIG. 19 as a practical application for a coat. In this application of the invention, a power-providing pocket (24) is coupled to a conductive path (9a) by use of a conductive fastening system (8c, 8d). The conductive path links the pocket (24) to the power supply (12) and the power supply to a wireless receiver (23). In this embodiment a charging station may be in the form of a hanger as shown in FIG. 19B.

As mentioned above, the materials used in the fabrication process of the smart handbag according to the present invention can comprise any type of material including: ethylene vinyl acetate (EVA), silicone, polyurethane (PU), canvas, leather , plastic, rubber, metallic materials and/or any other man-made and natural materials or any combination of them. In the preferred embodiment of the invention the outer bag shell is made from EVA or silicon rubber material with polyurethane (PU) or fabric straps or handles and the inner bag is made from polyurethane laminated (PUL) fabric, however many other material combinations can be used (e.g. silicon topping/outer bag shell w/non-PUL inner bag). Metallic surfaces can also be added to the outside surface of the outer bag shell as design elements or to distribute electrical signals and/or power.

It is important to notice that, if desired, the embodiment herein described can be modified so as the outer bag shell can be optionally omitted and the handles and/or straps can be attached directly to the inner bag which in this case becomes the only bag of the system.

It is therefore an objective of the present invention to obtain a handbag which can be used in multi-use cases, allowing at the same time for the full customization in each use-case as the user's needs change. Furthermore, it is the objective of the present invention to obtain a handbag which can encompass the technology many people are using or will be using proving to be a truly functional everyday use item. Finally, the means in which we power the technology and modularity of the modular handbag system can be further applied to any soft good item which is flexible and comprising of two material layers for which the system can be embedded.

As is clear to those skilled in the art, this basic system can be implemented in many specific ways, and the above descriptions are not meant to designate a specific implementation.

### DETAILED DESCRIPTION OF FIGURES

### A—FIG. 1

FIG. 1 show a first embodiment of a handbag according to the present invention. The modular handbag system (1) comprises an outer bag shell (2), an inner bag (3), one or more handbag straps or handles (4), a mechanism (5) to secure the inner bag to the outer bag shell. As can be seen in FIGS. 1A and 1C, the inner bag in FIG. 1B can be placed inside the outer bag shell (2) through an aperture (25) at the top of the outer bag shell. The inner bag can be closed with a closing mechanism (26) (e.g. a zipper) to safely stow personal belongings.

### B—FIG. 2

FIG. 2 shows a modular handbag system according to a further embodiment of the present invention where interruptions (10) to the surface of the outer bag shell (2) have been made to allow adequate ventilation to an element of the power delivery system. The same figures also depict a modular strap or handle (4), which has one strap length is attached to a connection mechanism (4a) to construct various strap lengths and carry styles (shoulder strap (FIG. 2A) and wristlet carry (FIG. 2B)).

### C—FIG. 3

FIG. 3 shows a side-view (FIG. 3A) and a top-view (FIG. 3B) of an outer bag shell (2) of a modular handbag system according to a further embodiment of the present invention. In this embodiment, the outer bag shell (2) presents at least one aperture (10) made to accommodate at least one plastic screw (6a) which is attached to a strap or handle (4). A screwcap (6b) is then used on the inner side of the outer bag shell to hold the screw (and therefore the strap or handle end (4)) in place. Said screwcap (6b) may comprise a first part of a two-part fastening snap system (8a) that is used to connect the inner bag (3) to the outer bag shell (2) or it can be used to directly connect the strap-inner bag-outer bag-system together

### D—FIG. 4

FIG. 4 shows a side-view FIG. 4A and a top-view FIG. 4B of an inner bag (3) of a modular handbag system with one or more portions of a fastening system (5) permanently attached to one or more of the exterior layer sides. Furthermore, the inner bag structure may be of various types of materials which may be washable and may have a closure mechanism (26) at the top to safely stow a user's belongings.

### E—FIG. 5

FIG. 5 shows an example of interior sidewall (11) of an inner bag wherein six first parts of a two-parts fastening system. i.e. snaps (8), have been placed in a permanent or semi-permanent way to form a 2 by 3 matrix to which modular attachments can be connected.

### F—FIG. 6

FIG. 6 shows an example of an interior of the inner bag (3) wherein two different sized modular attachments (7a and 7b) have been secured to the interior by joining the first portions of a fastening system located on the interior sidewall (11) of the inner bag (3) to the second portions of the said fastening system that have be attached to the modular articles (7).

### G—FIG. 7

FIG. 7 shows an x-ray view of an inner bag (3) according to a further embodiment of the present invention where six snap fasteners (8) have been connected to the power supply wiring (9a) with an optional connector (9b) to plug into the power supply. In this embodiment, a separate snap is shown to provide a positive (8c) and a negative (8d) polarity to simplify the system implementation. Furthermore, a close up is shown of the snap/wire construction, wherein the conductive material (9a) (e.g. conductive fabric, conductive surface or conductive wire) is sandwiched between a first portion of a fastening system, e.g. a snap (8a) and a second portion of a fastening system, e.g. a snap cap (8b). It is also possible to use a single snap for the positive and negative electrical current if the snap sufficiently isolates the two polarities from one another.

### H—FIG. 8

FIG. 8 depicts a cross section view of a smart bag according to the preferred embodiment of the present invention, where multiple modular attachments (7) have been attached to the inner wall (11) of the inner bag (3) (which is located inside the outer bag shell (2)). As it can be seen, thanks to the power distribution network, the depicted handbag has been customized to include some of the technological components previously discussed.

### I—FIG. 9

FIG. 9 shows an external sidewall of an inner bag (3) according to a further embodiment of the present invention, with two first portions of a snap (or other) fastening mechanism (5) to secure the inner bag (3) to the second portions of the fastening mechanism (5) located on a separate part of the handbag system (e.g. straps or outer bag shell). An optional “power snap” fastener (14) is also shown in the center of the inner bag exterior to be secured to the outer bag shell and/or power delivery system.

### J—FIG. 10

FIG. 10 shows a top view of an outer bag shell (2) according to a further embodiment of the present invention, where a power supply (12) has been added to the bottom of the bag so as to supply power to the technological modules by coupling to the embedded power delivery system through the use of a fastening system (14, 14b). In this embodiment the inner bag of the modular handbag system may be connected to a “power snap” fastener (14) in order to power the modular attachments inside of the inner bag.

### K—FIG. 11

FIG. 11 shows an x-ray view of an outer bag shell (2) in which an embedded power delivery system is located between a first and a second layer of the outer bag shell material. The conductive path (9a) is coupled to a flexible power supply (15) and a power snap (14) to supply power to the inner bag (3).

### L—FIG. 12

FIG. 12 shows the x-ray view of an inner bag according to a further embodiment of the present invention where an internal storage system (13) encloses a power supply (13c) to allow for wireless charging of a user's device that is in alignment with the wireless power transmitting coil.

### M—FIG. 13

FIG. 13 illustrates an x-ray/break out view of an inner bag storage system and a cross-section view of the inner bag construction to create the storage system where a first pocket (13a) of the storage system is connected to a shared lining with the second pocket (13b) of the storage system. As can be seen in the depicted construction, the storage system is located between the material layers (13d and 13e) of the inner bag allowing proper alignment while keeping 13c hidden from the user's view.

### N—FIG. 14

FIG. 14A depicts a break out view of an embodiment of the wireless transmitting device (13c) of FIGS. 12 & 13, where one or more wireless receiver coils (18), one or more rechargeable batteries (19), one or more wireless transmitting coils (20) and one or more control circuits housed between the walls (17a, 17b) of the power unit (13c). The one or more wireless receiving coil is used to recharge the battery and the one or more wireless transmitting coils are used to wirelessly recharge said user's compatible device (16). FIG. 14B depicts a side views of the wireless transmitting device. As shown, additional components may be present that allow for wired power transfer and status indication of the wireless transmitting device such as USB input/output (21), LED indicators (21a), and an on/off button or switch (21b).

### O—FIG. 15

FIG. 15 shows a side view of an embodiment of the present invention, where a charging base (22) comprising a wireless power transmitter is used to charge the power supply and/or modular attachments housed within the modular handbag system (1) through a wireless power receiver embedded in the modular handbag system and coupled to the supply and/or modular attachments.

### P—FIG. 16

FIG. 16 shows a block diagram of a possible implementation of the power delivery system in the soft good item and the charging base. As can be seen from the figure, a grounded power supply may be connected to a wireless power transmitter which may wirelessly couple to a receiver unit hosted in the soft good item (e.g. handbag) as a way to recharge the internal power system. The wireless receiver may be coupled to a power unit (e.g. battery) which may or may not include a wireless transmitter and/or may or may not be connected to an optional power delivery system (e.g. conductive path and conductive snap-style, or similar, fasteners). The power delivery system may be connected to optional modular attachments (e.g. UV sanitizing light) and/or a wireless transmitter (or receiver). Furthermore, the modular attachments may include a wireless transmitter or receiver to which a user's device may wirelessly connect.

### Q—FIG. 17

FIG. 17 depicts two example embodiments of the wireless charging stations used to recharge the power supply within the handbags. A vertical charging station FIG. 17A is useful to hold smaller handbags in an upright position. A flat, or horizontal, charging station FIG. 17B is the preferred method to hold a larger bag.

### R—FIG. 18

FIG. 18 shows a handbag according to the present invention which sits on a wireless charging station in an upright position. The charging station (22) keeps the handbag system in an ideal position for storing items safely while recharging the handbags power supply.

### S—FIG. 19

FIG. 19 shows a further embodiment of the present invention, where a power delivery system is incorporated into the lining of a coat. The conductive path (9a) couples the rechargeable power supply (12) with the accessory pocket (24), to which modular attachments can be connected and thus powered by the internal system. The rechargeable power supply (12) is then coupled to a wireless power receiver (23). A wireless charging hanger (27) is also shown in FIG. 19B which would be used to wirelessly recharge the power supply once the user hangs/stores the coat.

What is claimed is:

1. A flexible item comprising:
a first and a second layer of said flexible item;
a power delivery system, and
a fastening system;
wherein said power delivery system comprises a conductive path,
wherein said conductive path is located between said first and second layer;
wherein said fastening system comprises a first and a second portion, and
wherein said first portion of said fastening system is physically attached to said first layer and electrically coupled to said conductive path.

2. A flexible item according to claim 1, further comprising a modular attachment, wherein said second portion of said fastening system is physically attached to said modular attachment and electrically coupled to said first portion of said fastening system.

3. A flexible item according to claim 1,
wherein said flexible item is an element belonging to the group comprising: a bag, a clothing item, an outdoor shade structure, a temporary outdoor shelter, and a furniture covering.

4. A flexible item according to claim 1, further comprising:
a container, and
a removable strap or handle;
wherein said removable strap or handle can be removably connected to said container.

5. A flexible item according to claim 1, further comprising a first container and a second container;
wherein a said first container comprises a first and a second sidewall,
wherein a said first container removably inserts into said second container;
wherein said second container comprises:
a third and a fourth sidewall, and
an aperture in a said third sidewall;
wherein said aperture is located proximate to an element of said power delivery system.

6. A flexible item according to claim 1, further comprising a power supply unit electrically coupled to said conductive path.

7. A flexible item according to claim 1, further comprising a wireless charging coil electrically coupled to said conductive path.

8. A flexible item according to claim 1, further comprising a wireless power receiver and a charging base for hosting said flexible item, wherein said charging base comprises a wireless power transmitter.

9. A modular bag comprising:
a first container made of a first flexible material with a first opening located on an upper portion of said first container,
a second container made of a second flexible material with a second opening on an upper portion of said second container,
at least a modular attachment, and
a fastening system;
wherein said first container comprises a first and a second opposing sidewall,
wherein said second container comprises a third sidewall and a fourth sidewall, wherein said fastening system comprises at least a first portion and at least a second portion,
wherein said first portion of said fastening system is physically attached to at least one of said first and second container,
wherein said second portion of said fastening system is physically attached to said modular attachment,
and
wherein at least one of said first and second container comprises an aperture for removably attaching a strap or handle to said modular bag.

10. A modular bag according to claim 9,
wherein said first flexible material is a water-resistant material, and
wherein said second flexible material is a material belonging to a group comprising: a handbag textile, outdoor textile, indoor textile, silicon, rubber, polymer, and plastic.

11. A modular bag according to claim 9, further comprising at least said strap or handle,
wherein said strap or handle removably connects to at least one of said first and second container,
wherein said strap or handle comprises at least a first and a second portion removably connected to each other, and
wherein at least a portion of said strap or handle is made of a material belonging to the group comprising: a textile, metal, plastic, rubber, silicon, polymer, and a fibrous material which can bear weight over 1 lb.

12. A modular bag according to claim 9, wherein a rechargeable power supply is embedded in said first or said second flexible material of said first or said second container.

13. A modular bag according to claim 9,
wherein said modular bag comprises a power supply, and
a wireless power transmitter electrically coupled to said power supply.

14. A modular bag according to claim 9,
wherein said modular bag comprises a wireless power receiver and a charging base for hosting said modular bag, and
wherein said charging base comprises a wireless power transmitter.

15. A bag comprising:
a first container, and
a storage alignment system comprising:
a first and a second storage area,
a wireless charging coil, and
a power supply;
wherein said first container comprises a first and a second opposing sidewall,
wherein said first sidewall of said first container comprises said first storage area and said second storage area;
wherein said first and second storage area are at least partially overlapping, and
wherein said wireless charging coil is stored at least partially in said second storage area and is electrically coupled to said power supply.

16. A bag according to claim 15,
wherein a personal mobile device is stored in said first storage area of said storage alignment system,
wherein said storage system maintains said wireless charging coil and said personal mobile device in consistent proximity.

17. A bag according to claim 15 further comprising a second container,
wherein said first container can be removably placed inside an opening of said second container, and
wherein said second container is made of a water-resistant material.

18. A bag according to claim 17
wherein said second container comprises a third and a fourth opposing sidewall, and
wherein said water resistant material has an aperture in said third sidewall proximate to said power supply.

19. A bag according to claim 15, further comprising at least a removable strap orhandle, wherein said strap or handle comprises:
an elongated body, and
a connection mechanism;
wherein said elongated body is made of a material belonging to a group comprising: a textile, metal, plastic, and fibrous material which can bear weight over 1 lb,
wherein said elongated body is physically attached to said connection mechanism,
wherein said elongated body comprises a first and a second portion, and
wherein said first portion is removably connected to said second portion.

20. A bag according to claim 15, further comprising a wireless power receiver and a charging base for hosting said modular bag, wherein said charging base comprises a wireless power transmitter.
